(19) United States
(12) Patent Application Publication
(10) Pub. No.: US 2016/0005352 A1
(43) Pub. Date: Jan. 7, 2016

(54) TOUCH SENSING DEVICE

(71) Applicant: SAMSUNG ELECTRO-MECHANICS CO., LTD., Suwon-si (KR)

(72) Inventors: Hyun Jun KIM, Suwon-si (KR); Tah Joon PARK, Suwon-si (KR)

(73) Assignee: SAMSUNG ELECTRO-MECHANICS CO., LTD., Suwon-si (KR)

(21) Appl. No.: 14/754,813

(22) Filed: Jun. 30, 2015

(30) Foreign Application Priority Data
Jul. 3, 2014 (KR) 10-2014-0083328
Jan. 5, 2015 (KR) 10-2015-0000778

(51) Int. Cl. G09G 3/20; G06F 3/044; G06F 3/041

(52) U.S. Cl. CPC G09G 3/2092; G06F 3/0414; G06F 3/044; G06F 2203/04103; G06F 2203/04106; G06F 2203/04108; G09G 2310/0205; G09G 2310/08; G09G 2310/0218

(57) ABSTRACT

A touch sensing device may include a driving circuit unit applying driving signals, including a first driving signal and a second driving signal having different voltage levels, to a plurality of first electrodes; and a sensing circuit unit detecting levels of capacitance from a plurality of second electrodes intersecting with the plurality of first electrodes, wherein the driving circuit unit sequentially applies the first driving signal to the plurality of first electrodes and applies the second driving signal to a first electrode, close to a first electrode to which the first driving signal is applied, among the plurality of first electrodes, at a timing at which the first driving signal is applied.

### CROSS-REFERENCE TO RELATED APPLICATIONS

This application claims the priorities and benefits of Korean Patent Application Nos. 10-2014-0083328 filed on Jul. 3, 2014 and 10-2015-0000778 filed on Jan. 5, 2015, in the Korean Intellectual Property Office, the entire disclosures of which are incorporated herein by reference for all purposes.

### BACKGROUND

The present disclosure relates to a touch sensing device.

A capacitive type touchscreen includes a plurality of electrodes having a predetermined pattern and defining a plurality of nodes in which changes in capacitance are generated by touches. In the plurality of nodes distributed on a two-dimensional plane, changes in self-capacitance or in mutual-capacitance may be generated by touches. Coordinates of touches may be calculated by applying a weighted average calculating method, or the like, to the changes in capacitance generated in the plurality of nodes.

Recently, touchscreen devices have included styluses so as to receive fine touches. However, since differences in the levels of changes in capacitance generated by touches made with styluses may be relatively low, errors may occur when the touchscreen device determines the occurrence of a touch, and in a case in which the pressure of the stylus contact is not taken into account, the touch may not be precisely detected.

### RELATED ART DOCUMENT

(Patent Document 1) Korean Patent Laid-Open Publication No. 10-2014-0072586

### SUMMARY

An exemplary embodiment in the present disclosure may provide a touch sensing device capable of precisely detecting a fine change in capacitance and determining the degree of pressure exerted during writing by detecting a touch area.

According to an exemplary embodiment in the present disclosure, a touch sensing device may include: a driving circuit unit applying driving signals, including a first driving signal and a second driving signal having different voltage levels, to a plurality of first electrodes; and a sensing circuit unit detecting levels of capacitance from a plurality of second electrodes intersecting with the plurality of first electrodes, wherein the driving circuit unit sequentially applies the first driving signal to the plurality of first electrodes and applies the second driving signal to a first electrode close to a first electrode to which the first driving signal is applied, among the plurality of first electrodes, at a timing at which the first driving signal is applied.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a perspective view of an electronic apparatus including a touchscreen device according to an exemplary embodiment in the present disclosure;

FIG. 2 is a view of a panel unit that may be included in the touchscreen device according to an exemplary embodiment in the present disclosure;

FIG. 3 is a cross-sectional view of the panel unit that may be included in the touchscreen device according to an exemplary embodiment in the present disclosure;

FIG. 4 is a circuit diagram of a touchscreen device according to an exemplary embodiment in the present disclosure;

FIGS. 5A and 5B are views illustrating an example of a driving signal and changes in capacitance according to the driving signal;

FIGS. 6A and 6B are views illustrating driving signals and changes in capacitance according to the driving signals, according to a first exemplary embodiment in the present disclosure;

FIGS. 7A and 7B are views illustrating simulation data according to the first exemplary embodiment in the present disclosure;

FIGS. 8A through 8C are views illustrating the results of coordinate calculation according to the first exemplary embodiment in the present disclosure;

FIG. 9 is a view illustrating driving signals according to a second exemplary embodiment in the present disclosure;

FIGS. 10A and 10B are views illustrating simulation data according to the second exemplary embodiment in the present disclosure; and

FIG. 11 is a view illustrating a signal processing method of a calculating unit according to an exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

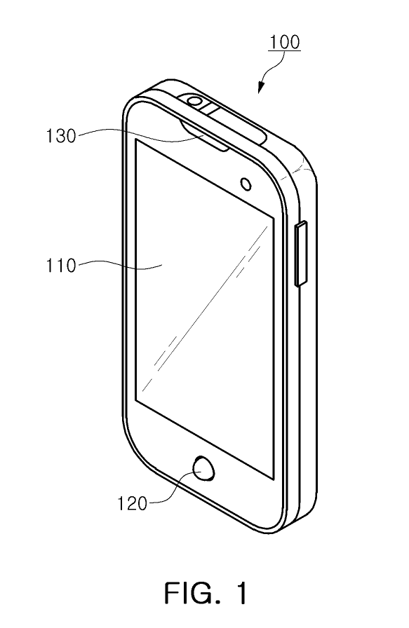

FIG. 1 is a perspective view of an electronic apparatus including a touchscreen device according to an exemplary embodiment in the present disclosure.

Referring to FIG. 1, an electronic apparatus 100 according to the present exemplary embodiment may include a display device 110 for displaying an image, an input unit 120, an audio unit 130 for outputting audio, and a touchscreen device (not illustrated in FIG. 1) formed integrally with the display device 110.

The touchscreen device according to an exemplary embodiment in the present disclosure may include a substrate and a panel unit having a plurality of electrodes provided on the substrate. Also, the touchscreen device may include a controller integrated circuit (a touch sensing device) including a capacitance detection circuit detecting changes in capacitance generated in the plurality of electrodes, an analog-to-digital conversion circuit converting an analog signal output by the capacitance detection circuit into a digital signal, a calculation circuit determining a touch using the converted digital data, and the like. The touchscreen device and the touch sensing device according to an exemplary embodiment in the present disclosure may detect coordinates and pressure of a touch, and may also be used in a fingerprint sensor to read a user's fingerprint.

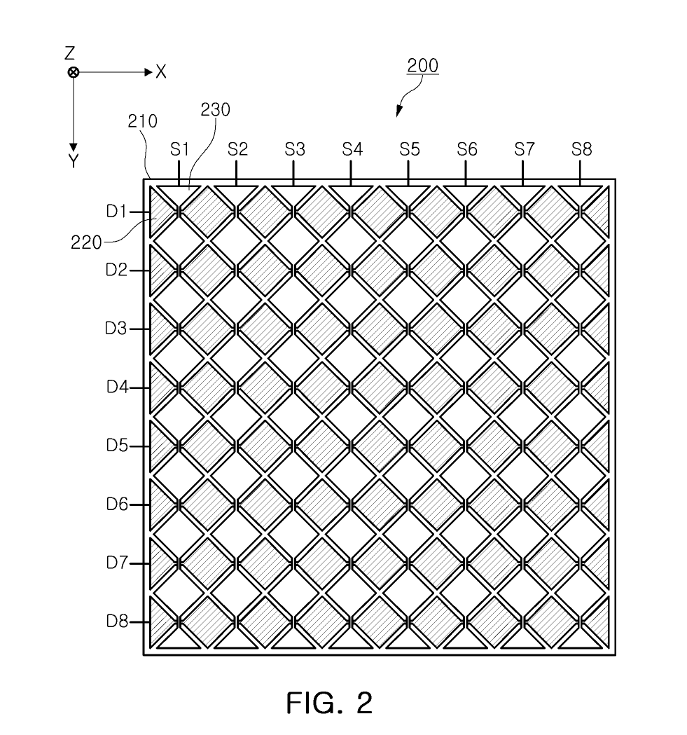

FIG. 2 is a view of a panel unit that may be included in the touchscreen device according to an exemplary embodiment in the present disclosure.

Referring to FIG. 2, a panel unit 200 according to the present exemplary embodiment may include a substrate 210 and a plurality of electrodes 220 and 230 provided on the substrate 210. Although not illustrated in FIG. 2, each of the plurality of electrodes 220 and 230 may be electrically connected to a wiring pattern of a circuit board attached to one end of the substrate 210 via wirings and bonding pads. The circuit board may be provided with a controller integrated circuit to detect a sensing signal generated in the plurality of electrodes 220 and 230 and determine a touch from the sensing signal.

The substrate 210 may be formed of a film made of a material such as polyethylene terephthalate (PET), polycarbonate (PC), polyethersulfone (PES), polyimide (PI), polymethylmethacrylate (PMMA), or a cyclo-olefin polymer (COP), or may be a glass substrate made of soda glass or tempered glass so as to provide high light transmittance.

The plurality of electrodes 220 and 230 may be provided on one surface or both surfaces of the substrate 210. Although the plurality of electrodes 220 and 230 are illustrated as having a rhomboid or diamond-shaped pattern in FIG. 2, the plurality of electrodes 220 and 230 may have various types of polygonal pattern such as a rectangular pattern, a triangular pattern, or the like. The plurality of electrodes 220 and 230 may be formed of a material such as an indium-tin oxide (ITO), an indium zinc oxide (IZO), a zinc oxide (ZnO), carbon nanotubes (CNT), or graphene having electrical conductivity, and may also be formed of any one of silver (Ag), aluminum (Al), chromium (Cr), nickel (Ni), molybdenum (Mo), and copper (Cu), or alloys thereof.

The plurality of electrodes 220 and 230 may include a first electrode 220 extended in an X axis direction and a second electrode 230 extended in a Y axis direction. The first electrodes 220 and the second electrodes 230 may be provided on both surfaces of the substrate 210, respectively, or may be provided on different substrates 210, respectively, to intersect with each other. In a case in which both the first electrodes 220 and the second electrodes 230 are provided on a single surface of the substrate 210, insulating layers may be partially formed at the points of intersection between the first electrodes 220 and the second electrodes 230.

Further, a predetermined printed region for visually blocking the wirings generally formed of an opaque metal may be provided in a region of the substrate 210 in which the wirings connected to the plurality of electrodes 220 and 230 are formed except for a region thereof in which the plurality of electrodes 220 and 230 are formed.

The touch sensing device (not illustrated) which is electrically connected to the plurality of electrodes 220 and 230 may provide a driving signal to the first electrodes 220 via channels defined as D1 to D8, and may be connected to channels defined as S1 to S8 to detect capacitance. In this case, capacitance may be used to determine that a touch has occurred, depending on changes in capacitance generated in points of intersection between the first electrodes 220 and the second electrodes 230.

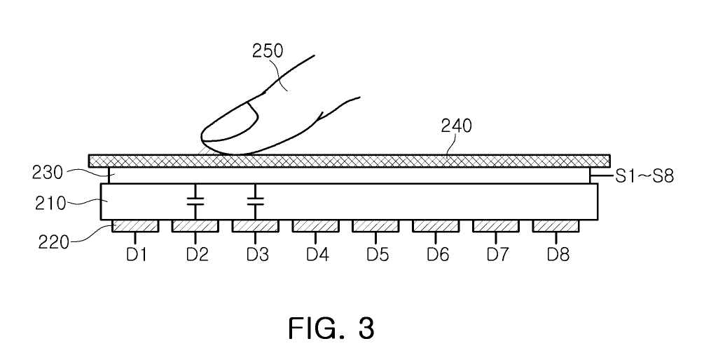

FIG. 3 is a cross-sectional view of the panel unit that may be included in the touchscreen device according to an exemplary embodiment in the present disclosure. FIG. 3 is a cross-sectional view of the panel unit 200 of FIG. 2 taken in a Y-Z direction. The panel unit 200 may further include a cover lens 240 to which a touch is applied, in addition to the substrate 210 and the plurality of sensing electrodes 220 and 230 as described above with reference to FIG. 2. The cover lens 240 may be provided on the second electrodes 230 used for detecting capacitance.

When the driving signal is applied to the first electrodes 220 via channels D1 to D8, capacitance may be generated between the first electrode 220 to which the driving signal is applied and the corresponding second electrode 230.

When a touch object 250 touches the cover lens 240, a change in capacitance may be generated in a node of the first electrode 220 and the second electrode 230 corresponding to a touch region. The change in capacitance may be proportional to an area of an overlapped region of the touch object 250, the first electrode 220 to which the driving signal is applied, and the corresponding second electrode 230. In FIG. 3, the capacitance generated between the first electrode 220 and the second electrode 230 connected to the channels D2 and D3, respectively, may be affected by the touch object 250.

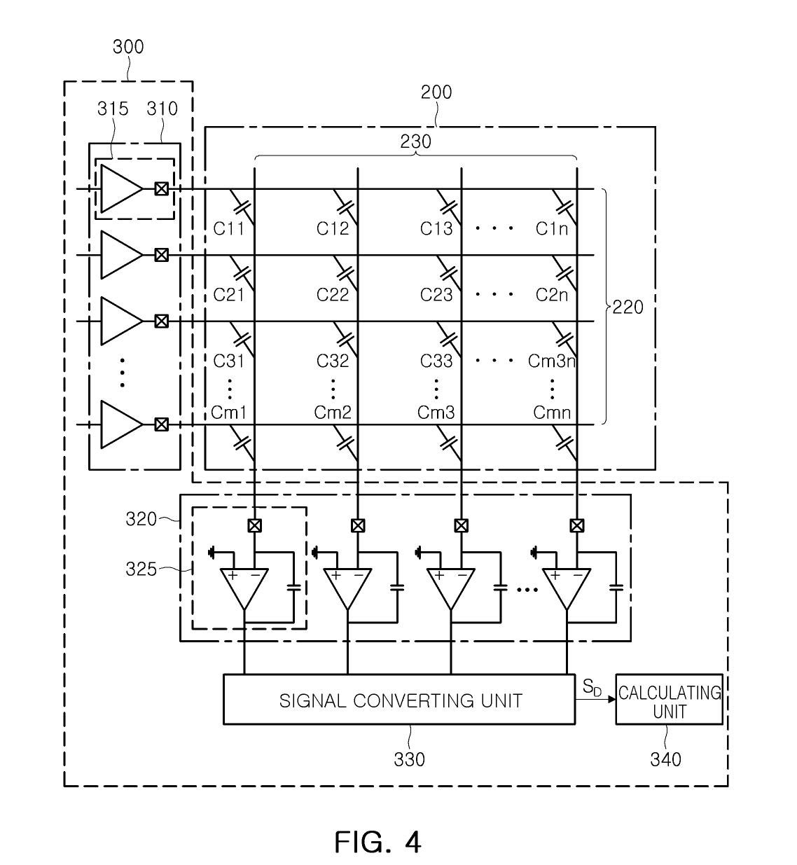

FIG. 4 is a circuit diagram of a touchscreen device according to an exemplary embodiment in the present disclosure. Referring to FIG. 4, the touchscreen device according to the present exemplary embodiment may include a panel unit 200 and a touch sensing device 300.

As described above, the panel unit 200 may include a substrate (not illustrated), the first electrodes 220 arrayed in a plurality of rows extended in a first axial direction (i.e., a horizontal direction of FIG. 4), and the second electrodes 230 arrayed in a plurality of columns extended in a second axial direction (i.e., a vertical direction of FIG. 4) intersecting with the first axial direction. Changes in capacitance may be generated in the points of intersection between the plurality of first electrodes 220 and the plurality of second electrodes 230. Node capacitors C11 to Cmn in FIG. 4 illustrate changes in capacitance generated in the points of intersection between the plurality of first electrodes 220 and the plurality of second electrodes 230 as capacitor components.

The touch sensing device 300 may include a driving circuit unit 310, a sensing circuit unit 320, a signal converting unit 330, and a calculating unit 340. In this case, the driving circuit unit 310, the sensing circuit unit 320, the signal converting unit 330, and the calculating unit 340 may be provided in a single integrated circuit (IC).

The driving circuit unit 310 may include at least one driving signal generating circuit 315 to apply a predetermined driving signal to the plurality of first electrodes 220 of the panel unit 200. The driving signal may be a square wave signal, a sine wave signal, a triangle wave signal, or the like, having a predetermined period and amplitude. Although FIG. 4 illustrates a case in which the driving signal generating circuits 315 are individually connected to the plurality of first electrodes 220, respectively, the driving circuit unit 310 may also be configured to include a single driving signal generating circuit 315 and apply the driving signal to the plurality of first electrodes 220, using a switching circuit.

The driving circuit unit 310 may sequentially apply the driving signal to each of the plurality of first electrodes 220. In addition, the driving circuit unit 310 may apply the driving signal to all of the first electrodes 220 simultaneously or selectively apply the driving signal to some of the plurality of first electrodes 220.

The driving circuit unit 310 according to an exemplary embodiment in the present disclosure may be repeatedly operated in a position sensing mode and a pressure sensing mode, wherein the driving signal applied to the plurality of first electrodes 220 in the position sensing mode may be different from the driving signal applied to the plurality of first electrodes 220 in the pressure sensing mode.

The sensing circuit unit 320 may detect respective levels of capacitance of the node capacitors C11 to Cmn from the plurality of second electrodes 230. The sensing circuit unit 320 may include a plurality of C-V converting circuits 325, each of which includes at least one operational amplifier and at least one capacitor, wherein the plurality of C-V converting circuits 325 may be connected to the plurality of second electrodes 230, respectively.

The plurality of C-V converting circuits 325 may convert respective levels of capacitance of the node capacitors C11 to Cmn into voltage signals to output analog signals. For example, the plurality of C-V converting circuits 325 may integrate respective levels of capacitance of the node capacitors C11 to Cmn to convert the same into predetermined voltages and output the converted voltages.

Here, the levels of capacitance may be concurrently detected from the plurality of second electrodes 230. Accordingly, the number of C-V converting circuits 325 may correspond to the number of second electrodes 230.

The signal converting unit 330 may generate a digital signal S_{D} from the analog signal output from the sensing circuit unit 320. For example, the signal converting unit 330 may include a time-to-digital converter (TDC) circuit measuring a time at which the analog signal output in voltage form by the sensing circuit unit 320 arrives at a predetermined reference voltage level and converting the measured time into the digital signal S_{D} or an analog-to-digital converter (ADC) circuit measuring an amount by which a level of the analog signal output from the sensing circuit unit 320 is changed for a predetermined time and converting the measured amount into the digital signal S_{D}.

The calculating unit 340 may determine that a touch has been applied to the panel unit 200 using the digital signal S_{D}. The calculating unit 340 may determine the number, coordinates, gesture operations, or the like, of touches applied to the panel unit 200 using the digital signal S_{D}.

The digital signal S_{D}, which is the basis for determining the touch by the calculating unit 340, may be data obtained by digitizing changes in capacitance occurring in the node capacitors C11 to Cmn, and particularly, may be data indicating a difference in levels of capacitance between a case in which the touch does not occur and a case in which the touch occurs. Typically, in a capacitive type touchscreen device, since the capacitance is decreased in a region that is touched by a conductive material as compared with a region that is not touched, a change in capacitance in the region that is touched by the conductive material may be larger than a change in capacitance in the region that is not touched.

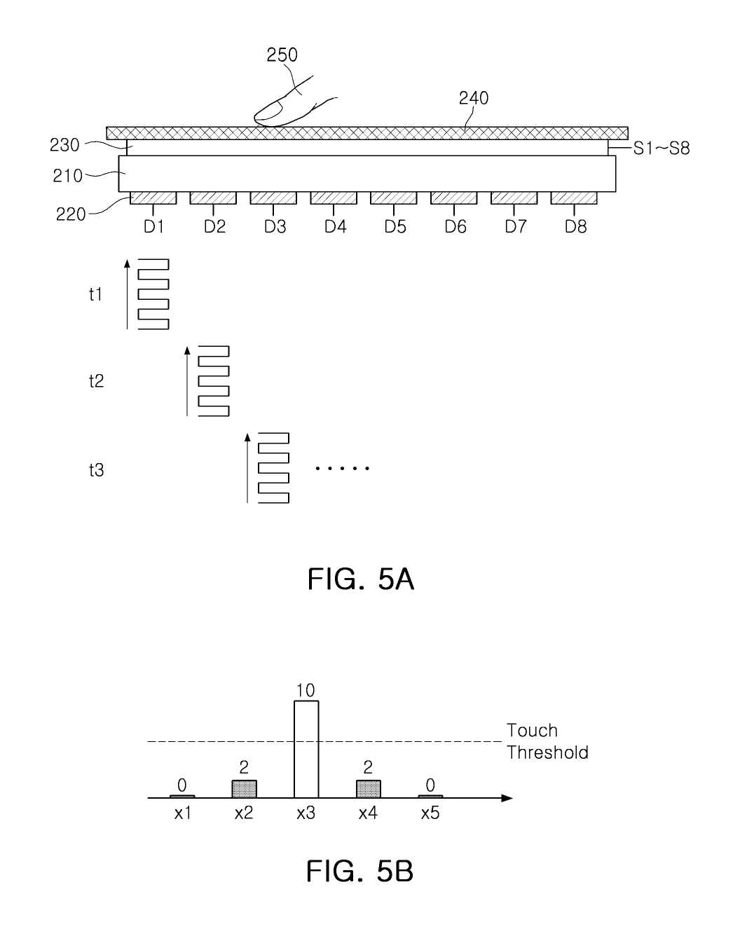

FIGS. 5A and 5B are views illustrating an example of a driving signal and changes in capacitance according to the driving signal. Specifically, FIG. 5A is a view illustrating a single driving signal which is sequentially applied, and FIG. 5B is a view illustrating changes in capacitance according to the driving signal of FIG. 5A.

In FIG. 5A, the case in which the first electrodes X1 to X8 are connected to the channels D1 to D8, respectively, and the driving signal is applied to the first electrodes X1 to X8 via the channels D1 to D8. In addition, the touch object 250 is positioned to correspond to the first electrode X3.

As illustrated in FIG. 5A, the driving signal may be sequentially applied to the channels D1 to D8, and changes in capacitance may be detected via the channels S1 to S8.

Referring to FIG. 5B, in order to remove noise introduced to the touch panel, or the like, from the detected change in capacitance, only a change in capacitance greater than or equal to a touch threshold may be determined as effective touch data. At this time, in a case in which a change in capacitance occurs in the touch panel due to a touch by a very small stylus or a proximity touch such as a hovering gesture, only the change in capacitance detected in a node corresponding to the first electrode X3 may be determined as the effective touch data as illustrated in FIG. 5B. However, in a case in which changes in capacitance detected in a small number of nodes are determined as effective touch data, the accuracy of coordinate calculation may be significantly reduced, and thus, a post-processing unit may recognize the effective touch data as peak data and remove the same.

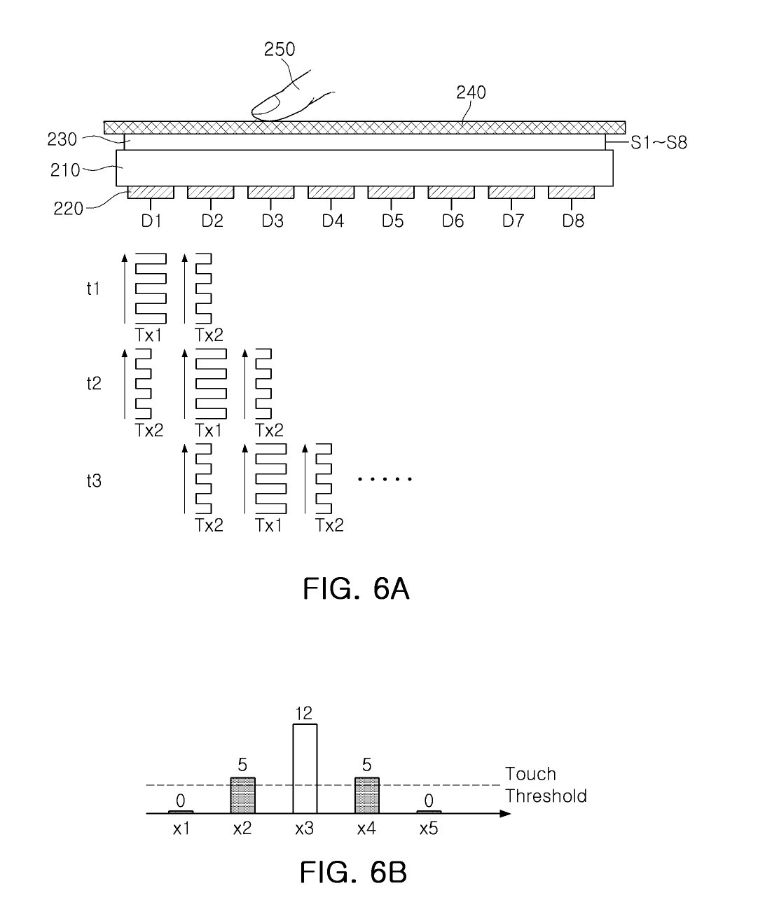

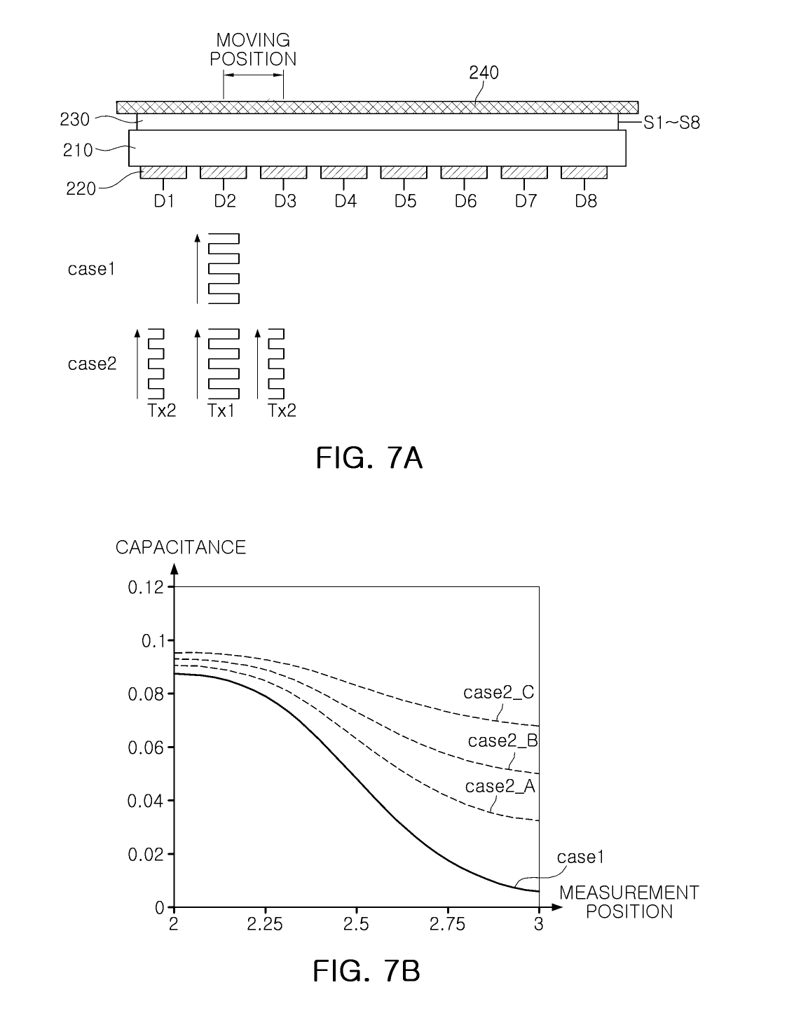

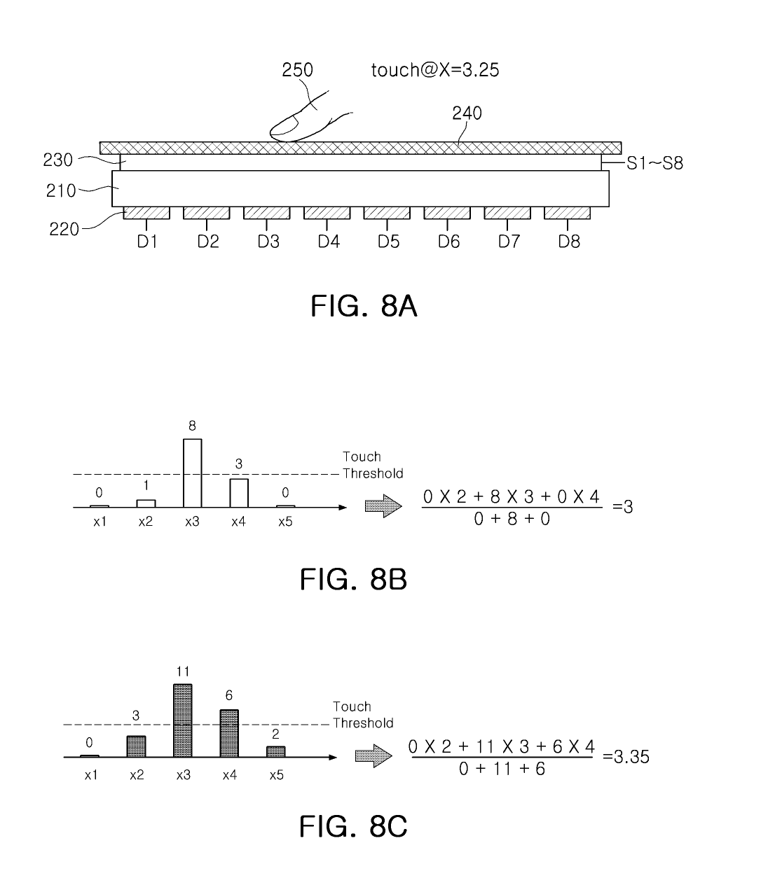

FIGS. 6A and 6B are views illustrating driving signals and changes in capacitance according to the driving signals, according to a first exemplary embodiment in the present disclosure, and FIGS. 7A and 7B are views illustrating simulation data according to the first exemplary embodiment in the present disclosure. In addition, FIGS. 8A through 8C are views illustrating the results of coordinate calculation according to the first exemplary embodiment in the present disclosure.

The driving signals according to the first exemplary embodiment in the present disclosure may be applied in a position sensing mode, and a position of the touching object such as the stylus may be detected in the position sensing mode.

Hereinafter, a driving signal applying scheme according to the first exemplary embodiment in the present disclosure will be described with reference to FIGS. 6 through 8.

FIG. 6A is a view illustrating driving signals according to the first exemplary embodiment in the present disclosure, and FIG. 6B is a view illustrating changes in capacitance according to the driving signals of FIG. 6A.

The driving circuit unit 310 may apply at least two driving signals as illustrated in FIG. 6A. Specifically, the driving signals may include a first driving signal Tx1 and a second driving signal Tx2, and the driving circuit unit 310 may sequentially apply the first driving signal Tx1 to the first electrodes X1 to X8 via the channels D1 to D8 and may apply the second driving signal Tx2 to at least one first electrode, close to the first electrode to which the first driving signal Tx1 is applied, simultaneously. In this case, a voltage level of the first driving signal Tx1 may be higher than a voltage level of the second driving signal Tx2. For example, the voltage level of the first driving signal Tx1 may be twice the voltage level of the second driving signal Tx2.

For example, as illustrated in FIG. 6A, the driving circuit unit 310 may apply the first driving signal Tx1 to the first electrode X1 via the channel D1 and may apply the second driving signal Tx2 to the first electrode X2 via the channel D2 at a first timing t1. Similarly, the driving circuit unit 310 may apply the first driving signal Tx1 to the first electrode X2 via the channel D2 and may apply the second driving signal Tx2 to the first electrodes X1 and X3 via the channel D2 at a second timing t2.

In a case in which the driving signals are applied as illustrated in FIG. 6A, the changes in capacitance may be obtained as illustrated in FIG. 6B. It may be understood from a comparison between FIGS. 5B and 6B that changes in capacitance greater than or equal to the touch threshold are also detected in the first electrodes X2 and X4 as well as in the first electrode X3.

Although the case in which the driving signals are applied to three first electrodes is illustrated by way of example, the driving signals according to the first exemplary embodiment in the present disclosure may be simultaneously applied to three or more first electrodes. Specifically, when the driving circuit unit 310 simultaneously applies m driving signals to m first electrodes among the plurality of first electrodes (where m is an odd number greater than or equal to 3), voltage levels of the driving signals applied to 1st to nth first electrodes among the m first electrodes may be increased as levels of the m first electrodes are increased, and voltage levels of the driving signals applied to nth to mth first electrodes among the m first electrodes may be decreased as levels of the m first electrodes are increased, where n is (1+m)/2. Here, the levels of electrodes refer to an index on the basis of the order of the electrodes, and the levels of the electrodes may be increased one by one according to the order of the electrodes. For example, a level of a first electrode among the m first electrodes of FIG. 6 may be 1, and a level of a second electrode close to the first electrode may be 2.

If m is 5, the driving circuit unit 310 applies the driving signals to five first electrodes among the plurality of first electrodes. The voltage levels of the driving signals applied to 1st to 3rd electrodes (3=(1+5/2)) of the five first electrodes may be increased as the levels of the first electrodes are increased, and the voltage levels of the driving signals applied to the 3rd to 5th electrodes of the five first electrodes may be decreased as the levels of the electrodes are increased.

In this case, the driving circuit unit 310 may sequentially apply the m driving signals to each group by grouping the plurality of first electrodes into a plurality of groups, wherein the plurality of groups may share m−1 first electrodes. For example, if m is 5, the driving circuit unit 310 may apply the five first driving signals to the 1st to 5th first electrodes and may apply the five driving signals to the 2nd to 6th first electrodes at a next timing.

FIGS. 7A and 7B are views illustrating simulation data according to the first exemplary embodiment in the present disclosure. In FIGS. 7A and 7B, case 1 relates to a Comparative Example, and case 2 relates to an inventive example according to the first exemplary embodiment in the present disclosure. FIG. 7B is a view illustrating changes in capacitance measured while the touch object is moved from the first electrode X2 to the first electrode X3 as illustrated in FIG. 7A in a case in which the driving signals are applied as illustrated in FIG. 7A.

Case 1 in FIG. 7A illustrates a single driving signal applied via the channel D2. Case 2 illustrates driving signals according to the first exemplary embodiment in the present disclosure, wherein the voltage level of the driving signal applied via the channel D2 may be higher than the voltage levels of the driving signals applied via the channels D1 and D3. When the voltage level of the first driving signal Tx1 is 1 in case 2_A, case 2_B, and case 2_C of FIG. 7B, the voltage level of the second driving signal Tx2 may correspond to 0.3 in case 2_A, 0.5 in case 2_B, and 0.7 in case 2_C.

Referring to FIG. 7B, it may be seen from case 1 that an area of a portion of the first electrode X3 which may be coupled to the driving signal is reduced based on a boundary between the first electrodes X2 and X3 so that changes in capacitance are sharply decreased.

Compared with case 1, case 2_B ensures a great measured change in capacitance and an appropriate gradient even in a case in which a measurement position is positioned on the first electrode X3, accuracy, linearity, and the like of the coordinate calculation by interpolation may be significantly improved.

Meanwhile, in comparing case 2_A and case 2_C with case 2_B, a voltage level of a neighboring channel is decreased (case 2_A) or increased (case 2_C). If the voltage level of each second driving signal Tx2 is determined depending on characteristics of an electrode pattern, maximum accuracy and linearity of the coordinate calculation may be secured.

FIGS. 8A through 8C are views illustrating the results of coordinate calculation according to the first exemplary embodiment in the present disclosure.

Referring to FIG. 8A, the touch object 250 touches a position corresponding to X=3.25, which is between the first electrodes X3 and X4. The calculating unit 340 may obtain changes in capacitance via the channels S1 to S8 connected to the second electrodes and may calculate coordinates of the touch from the changes in capacitance. For example, the calculating unit 340 calculates the coordinates of the touch in one direction using Equation 1 below. In Equation 1, Xi indicates a position of the first electrode Xi, and ΔCmi indicates a capacitance value corresponding to the first electrode Xi.

$$\frac{Δ {C}_{m 1} \times {X}_{1} + Δ {C}_{m 2} \times {X}_{2} + Δ {C}_{m 3} \times {X}_{3}}{Δ {C}_{m 1} + Δ {C}_{m 2} + Δ {C}_{m 3}} \qquad [ Equation 1 ]$$

FIG. 8B is a view illustrating changes in capacitance according to a single driving signal which is sequentially applied, and FIG. 8B is a view illustrating changes in capacitance according to the driving signal according to an exemplary embodiment in the present disclosure. In a case in which only a change in capacitance greater than or equal to a touch threshold among the sensed changes in capacitance is determined as effective touch data in order to remove noise, or the like, only the change in capacitance detected from the first electrode X3 is determined as the effective touch data in FIG. 8B, and thus, the calculated touch position may be X=3, which has a significant difference from an actual touch position of X=3.25. On the other hand, since the changes in capacitance detected from the first electrode X4 as well as the first electrode X3 are determined as the effective touch data in FIG. 8C, the calculated touch position may be X=3.35, which is closest to the actual touch position of X=3.25.

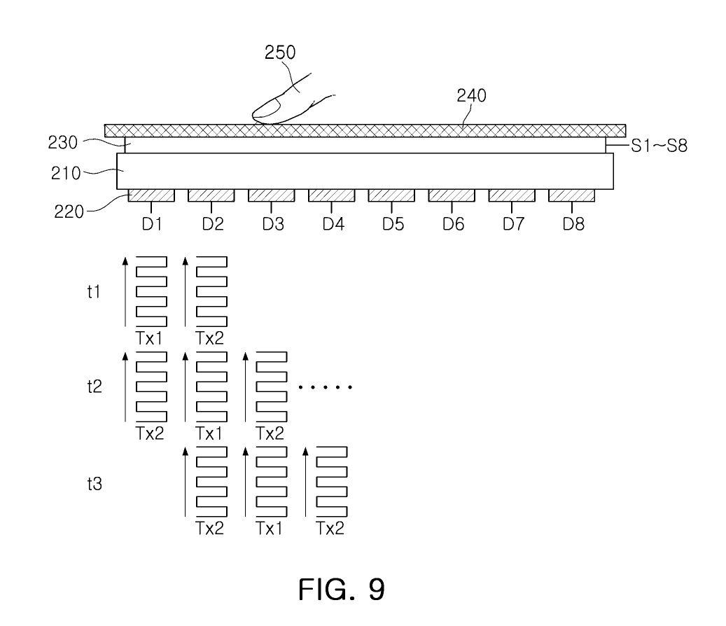

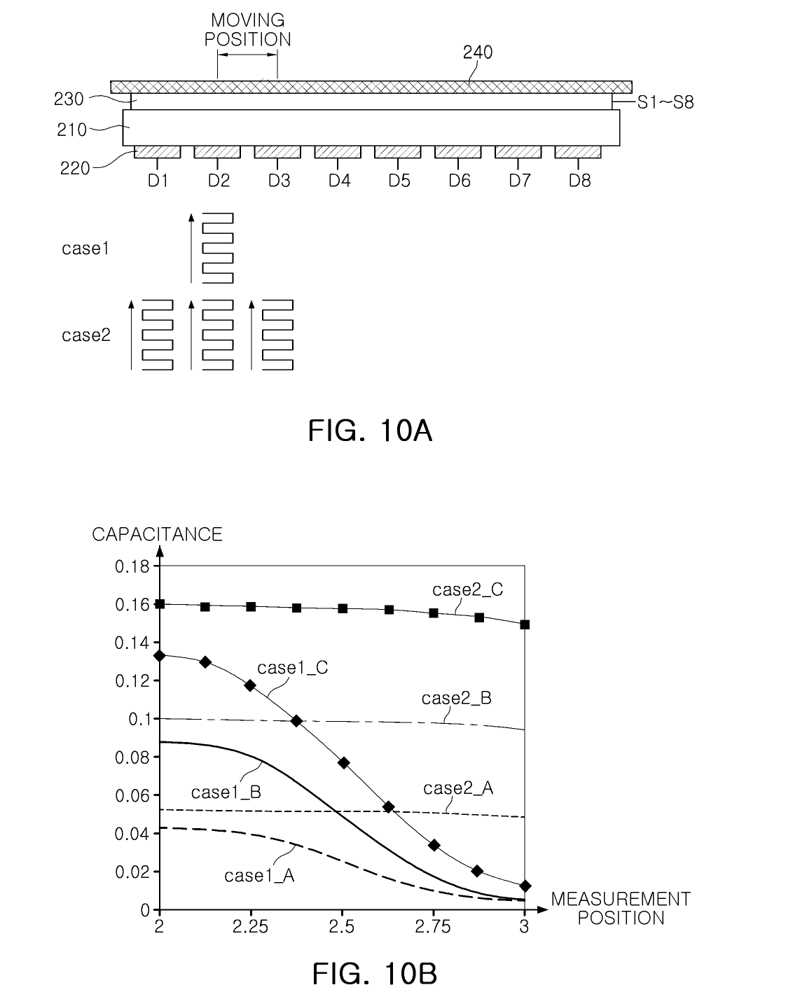

FIG. 9 is a view illustrating driving signals according to a second exemplary embodiment in the present disclosure, and FIGS. 10A and 10B are views illustrating simulation data according to the second exemplary embodiment in the present disclosure.

The driving signals according to the second exemplary embodiment in the present disclosure may be applied in a pressure sensing mode, and pressure of the touch applied to the touch panel may be determined in the pressure sensing mode by detecting a touch area of the touch object such as a stylus including a conductive rubber tip, rather than the position of the touch object.

Hereinafter, a driving signal applying scheme according to the second exemplary embodiment in the present disclosure will be described with reference to FIGS. 9 and 10.

The driving circuit unit 310 may apply at least two driving signals as illustrated in FIG. 9. Specifically, the driving signals may include a first driving signal Tx1 and a second driving signal Tx2, and the driving circuit unit 310 may sequentially apply the first driving signal Tx1 to the first electrodes X1 to X8 via the channels D1 to D8 and may apply the second driving signal Tx2 to at least one first electrode, close to the first electrode to which the first driving signal is applied, simultaneously. In this case, a voltage level of the first driving signal Tx1 may be equal to a voltage level of the second driving signal Tx2.

For example, as illustrated in FIG. 9, the driving circuit unit 310 may apply the first driving signal Tx1 to the first electrode X1 via the channel D1 and may apply the second driving signal Tx2 to the first electrode X2 via the channel D2 at a first timing t1. Similarly, the driving circuit unit 310 may apply the first driving signal Tx1 to the first electrode X2 via the channel D2 and may apply the second driving signal Tx2 to the first electrodes X1 and X3 via the channel D2 at a second timing t2.

Although the case in which the driving signals are applied to three first electrodes is illustrated by way of example, the driving signals according to the second exemplary embodiment in the present disclosure may be simultaneously applied to three or more first electrodes. Specifically, the driving circuit unit 310 may simultaneously apply m driving signals to m first electrodes (m is an integer greater than or equal to 3) among the plurality of first electrodes.

In this case, the driving circuit unit 310 may sequentially apply the m driving signals to each group by grouping the plurality of first electrodes into a plurality of groups, wherein the plurality of groups may share m−1 first electrodes. For example, if m is 5, the driving circuit unit 310 may apply five driving signals to 1st to 5th first electrodes and may apply the five driving signals to 2nd to 6th first electrodes at a next timing.

FIGS. 10A and 10B are views illustrating simulation data according to the second exemplary embodiment in the present disclosure. Case 1 of FIGS. 10A and 10B relates to a Comparative Example, and Case 2 relates to an inventive example according to the second exemplary embodiment in the present disclosure. FIG. 10B is a view illustrating changes in capacitance measured while the touch object is moved from the first electrode X2 to the first electrode X3 of FIG. 10A in a case in which the driving signals are applied as illustrated in FIG. 10A.

In FIG. 10A, case 1 illustrates a single driving signal applied via the channel D2, and case 2 illustrates the driving signals according to the second exemplary embodiment in the present disclosure, wherein voltage levels of the driving signals applied via the channels D1 to D3 may be the same as one another.

In FIG. 10B, a stylus of 1 mm is used as a touch object in case 1_A and case 2_A, a stylus of 2 mm is used as a touch object in case 1_B and case 2_B, and a stylus of 3 mm is used as a touch object in case 1_C and case 2_C.

It may be seen from case 1_A, case 1_B, and case 1_C of FIG. 10B that an area of the first electrode X3 which may be coupled to the driving signal is reduced based on a boundary between the first electrodes X2 and X3, so that changes in capacitance are sharply decreased.

In comparing case 2_A, case 2_B, and case 2_C of FIG. 10B with case 1_A, case 1_B, and case 1_C, one driving signal is applied in case 1_A, case 1_B, and case 1_C, while three driving signals are applied in case 2_A, case 2_B, and case 2_C, and thus, an area of the first electrodes is expanded three times. Therefore, unlike case 1_A, case 1_B, and case 1_C, case 2_A, case 2_B, and case 2_C show that even in a case in which the stylus is positioned on the first electrode X3, the measured change in capacitance is not significantly different from a case in which the stylus is positioned on the first electrode X2. Referring to a flat gradient associated with the changes in capacitance described above, in the case in which the driving signals according to the second exemplary embodiment are applied, it may be seen that the changes in capacitance may be proportional to the touch area, irrespective of the position of the touching object such as the stylus moving between the first electrodes X2 and X3. As a result, the pressure of the touch applied to the touch panel may be sensed by detecting the touch area of the stylus.

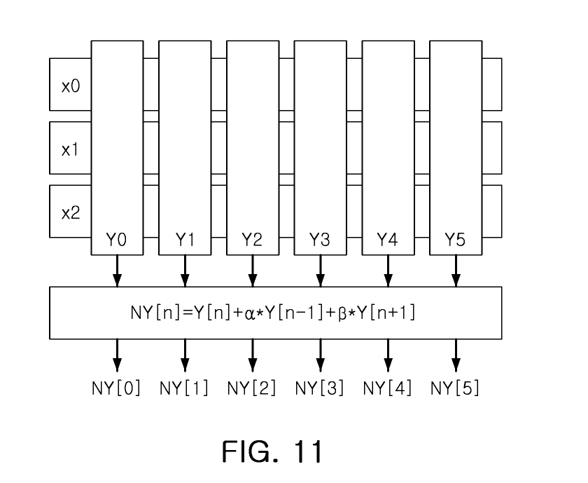

FIG. 11 is a view illustrating a signal processing method of the calculating unit 340 according to an exemplary embodiment in the present disclosure.

Referring to FIG. 11, the calculating unit 340 may calculate changes in capacitance detected from a plurality of second electrodes according to Equation 2 below. In this case, Y[x] denotes a change in capacitance detected from an x-th electrode of the second electrodes, and NY[x] denotes a change in capacitance of the x-th electrode of the second electrodes calculated according to Equation 2. In Equation 2, α and β denote weights, and α and β may be greater than 0 and less than 1.

In a case in which a change in capacitance is calculated according to Equation 2, the changes in capacitance with respect to the touch may be increased.

NY[n]=Y[n]+α*Y[n−1]+β*Y[n+1] [Equation 2]

Although the case in which the calculating unit 340 determines the touch applied to the electrode disposed in the center among the three electrodes using the changes in capacitance detected from the three second electrodes is illustrated by way of example, the calculating unit according to an exemplary embodiment in the present disclosure may determine the touch using the changes in capacitance detected from three or more second electrodes. For example, when the calculating unit 340 determines a touch applied to an nth electrode among the plurality of second electrodes, the calculating unit 340 may calculate the changes in capacitance detected from an n−x-th second electrode to an n+x-th second electrode (n is a natural number greater than or equal to 2). In this case, the calculating unit 340 may apply weights to the changes in capacitance detected from the n−x-th to n−1-th second electrodes and the changes in capacitance detected from the n+1-th to n+x-th second electrodes. At this time, a higher weight may be applied to a change in capacitance detected from a second electrode which is closest to the nth second electrode.

As set forth above, according to exemplary embodiments in the present disclosure, the touch sensing device may precisely detect a fine change in capacitance and determining the degree of pressure exerted during writing by detecting the touch area.

While exemplary embodiments have been shown and described above, it will be apparent to those skilled in the art that modifications and variations could be made without departing from the scope of the present invention as defined by the appended claims.

What is claimed is:

1. A touch sensing device comprising:
a driving circuit unit applying driving signals, including a first driving signal and a second driving signal having different voltage levels, to a plurality of first electrodes; and
a sensing circuit unit detecting levels of capacitance from a plurality of second electrodes intersecting with the plurality of first electrodes,
wherein the driving circuit unit sequentially applies the first driving signal to the plurality of first electrodes and applies the second driving signal to a first electrode, close to a first electrode to which the first driving signal is applied, among the plurality of first electrodes, at a timing at which the first driving signal is applied.

2. The touch sensing device of claim 1, wherein a voltage level of the first driving signal is higher than a voltage level of the second driving signal.

3. The touch sensing device of claim 2, wherein the voltage level of the first driving signal corresponds to two times the voltage level of the second driving signal.

4. The touch sensing device of claim 1, further comprising a calculating unit determining a touch from a change in capacitance,
wherein the calculating unit calculates the change in capacitance on the basis of a level of capacitance detected from an nth second electrode among the plurality of second electrodes and a level of capacitance detected from a second electrode close to the nth second electrode, at the time of determining the touch applied to the nth second electrode.

5. The touch sensing device of claim 4, wherein the calculating unit applies a weight to the level of capacitance detected from the second electrode close to the nth second electrode.

6. The touch sensing device of claim 5, wherein the weight is greater than 0 and less than 1.

7. A touch sensing device comprising:
a driving circuit unit applying driving signals to a plurality of first electrodes; and
a sensing circuit unit detecting the levels of capacitance from a plurality of second electrodes intersecting with the plurality of first electrodes,
wherein the driving circuit unit simultaneously applies m driving signals to m first electrodes among the plurality of first electrodes,
voltage levels of driving signals applied to 1st to nth first electrodes among the m first electrodes are increased as levels of the m first electrodes are increased,
voltage levels of driving signals applied to nth to mth first electrodes among the m first electrodes are decreased as the levels of the m first electrodes are increased, and
where n is (1+m)/2.

8. The touch sensing device of claim 7, wherein the driving circuit unit groups the plurality of first electrodes into a plurality of groups and sequentially applies the m driving signals to each group, and
the plurality of groups share m−1 first electrodes.

9. The touch sensing device of claim 7, further comprising a calculating unit determining a touch from a change in capacitance,
wherein the calculating unit calculates the change in capacitance on the basis of levels of capacitance detected from an n−x-th second electrode to an n+x-th second electrode at the time of determining the touch applied to an nth second electrode among the plurality of second electrodes, where x is a natural number greater than or equal to 2.

10. The touch sensing device of claim 9, wherein the calculating unit applies weights to levels of capacitance detected from n−x-th to n−1-th second electrodes and levels of capacitance detected from n+1-th to n+x-th second electrodes.

11. The touch sensing device of claim 10, wherein the calculating unit applies a higher weight to a level of capacitance detected from a second electrode which is closest to the nth second electrode.

12. A touch sensing device comprising:
a driving circuit unit applying driving signals to a plurality of first electrodes; and
a sensing circuit unit detecting levels of capacitance from a plurality of second electrodes intersecting with the plurality of first electrodes,
wherein the driving circuit unit simultaneously applies m driving signals to m first electrodes among the plurality of first electrodes in a position sensing mode,
voltage levels of driving signals applied to 1st to nth first electrodes among the m first electrodes are increased as levels of the m first electrodes are increased,
voltage levels of driving signals applied to nth to mth first electrodes among the m first electrodes are decreased as the levels of the m first electrodes are increased,
where n is (1+m)/2, and
the driving circuit unit simultaneously applies the m driving signals to the m first electrodes among the plurality of first electrodes in a pressure sensing mode, and
voltage levels of the driving signals applied to the m first electrodes are the same as one another.

13. The touch sensing device of claim 12, wherein the position sensing mode and the pressure sensing mode are repeatedly performed.

14. The touch sensing device of claim 12, wherein the driving circuit unit groups the plurality of first electrodes into a plurality of groups and sequentially applies the m driving signals to each group, and
the plurality of groups share m−1 first electrodes.

15. A touch sensing device comprising:
a driving circuit unit applying driving signals to a plurality of first electrodes;
a sensing circuit unit detecting levels of capacitance from a plurality of second electrodes intersecting with the plurality of first electrodes; and
a calculating unit determining a touch from a change in capacitance,
wherein the calculating unit calculates the change in capacitance on the basis of a level of capacitance detected from an nth second electrode among the plurality of second electrodes and a level of capacitance detected from a second electrode close to the nth second electrode, at the time determining the touch applied to the nth second electrode.

16. The touch sensing device of claim 15, wherein the calculating unit applies a weight to the level of capacitance detected from the second electrode close to the nth second electrode.

17. The touch sensing device of claim 16, wherein the weight is greater than 0 and less than 1.

18. A touch sensing device comprising:
a driving circuit unit applying driving signals to a plurality of first electrodes;
a sensing circuit unit detecting levels of capacitance from a plurality of second electrodes intersecting with the plurality of first electrodes; and
a calculating unit determining a touch from a change in capacitance,
wherein the calculating unit calculates the change in capacitance on the basis of levels of capacitance detected from n−x-th to n+x-th second electrodes at the time of determining the touch applied to an nth second electrode among the plurality of second electrodes, where x is a natural number greater than or equal to 2.

19. The touch sensing device of claim 18, wherein the calculating unit applies weights to the levels of capacitance detected from n−x-th to n−1-th second electrodes and the levels of capacitance detected from n+1-th to n+x-th second electrodes.

20. The touch sensing device of claim 19, wherein the calculating unit applies a higher weight to a level of capacitance detected from a second electrode which is closest to the nth second electrode.
